(19) United States
(12) Patent Application Publication
(10) Pub. No.: US 2014/0052596 A1
(43) Pub. Date: Feb. 20, 2014

(54) FINANCIAL REPORTING FOR CONTENT CONSUMPTION

(71) Applicant: PixelMags Inc., Los Angeles, CA (US)

(72) Inventors: Ryan Marquis, Corona, CA (US); Mark Stubbs, Ampthill (GB)

(21) Appl. No.: 13/970,455

(22) Filed: Aug. 19, 2013

Related U.S. Application Data
(60) Provisional application No. 61/684,620, filed on Aug. 17, 2012.

(51) Int. Cl. G06Q 40/00

(52) U.S. Cl. CPC G06Q 40/00
USPC 705/35

(57) ABSTRACT

Systems and methods are provided for distributing revenue derived from content consumption to publishers of the content and to a content aggregator.

### CROSS-REFERENCE TO RELATED APPLICATIONS

This application is a nonprovisional of U.S. Provisional Application No. 61/684,620, filed Aug. 17, 2013, the entirety of which is incorporated herein by reference.

### BACKGROUND

One of the benefits of the Internet is the ability to access information from a wide variety of sources using a wide variety of devices. There are many entities and organizations that have their own websites. Radio stations, merchants, and others often have their own web sites. Some websites operate as portals, or search engines, or both. There are websites dedicated to helping consumers find the best flight, the lowest price, or the best deal.

These websites face many challenges, however. One of the challenges is capturing traffic. Capturing traffic or driving users to their websites is a concern for many websites because traffic is usually related to revenue. The ability of a website (or the entity operating the website) to generate revenue from users typically requires the users to actually visit the website.

Even if a website receives a lot of traffic, the website is still faced with the problem of turning that traffic into revenue. This problem is particularly troublesome for organizations that deal in media. Newspapers and magazine publishers are examples of organizations that often have difficulty in monetizing their online presence. There are many reasons, some of which includes the fact that certain media (e.g., news reports) are available for many sources.

Some entities have begun to restrict access to their online content. However, this reduces traffic and has an impact on revenue. There is therefore a need for systems and methods that can improve access to content and that enable entities to monetize their content.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an example of a system for distributing content from publishers to users and illustrates the ability to share revenue generated from the consumption of the content;

FIG. 2 illustrates another view of a portion of the system illustrated in FIG. 1 and illustrates user accounts and associated data related to the consumption of content from content publishers;

FIG. 3 is a flow diagram illustrating an example for distributing revenue generated from the consumption of content; and

FIG. 4 illustrates an example of a method for reporting on the consumption of content in accordance with the embodiments disclosed herein.

### DETAILED DESCRIPTION OF EMBODIMENTS OF THE INVENTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Embodiments of the invention enable content providers (e.g., magazine publishers and other entities) to monetize their content. In one example, a user's device is loaded with software (e.g., an app) that can provide access to the content of multiple content providers. Revenue is generated when a user subscribes to the content being provided. The app or software then monitors which content is accessed. In the context of digital magazines, the app may monitor how long the user interacts with or consumes a particular title. At the end of a predetermined period (e.g., monthly), the subscription fee paid by the user can be allocated to the various content providers according to how the user interacted with the various titles. The publisher of each title receives a portion of the subscription fee. Titles offered or available through the app (or online) that were not viewed or otherwise consumed by the user receive no part of the subscription fee for that period.

Embodiments of the invention can thus make content more available to users. At the same time, the publishers of content consumed by the users are compensated. In this context, embodiments of the invention are generally directed to systems and methods for distributing revenue related to content. Embodiments of the invention enable a user to consume content from multiple content providers. At least some of the revenue can then be distributed to the content providers associated with the content consumed by the user.

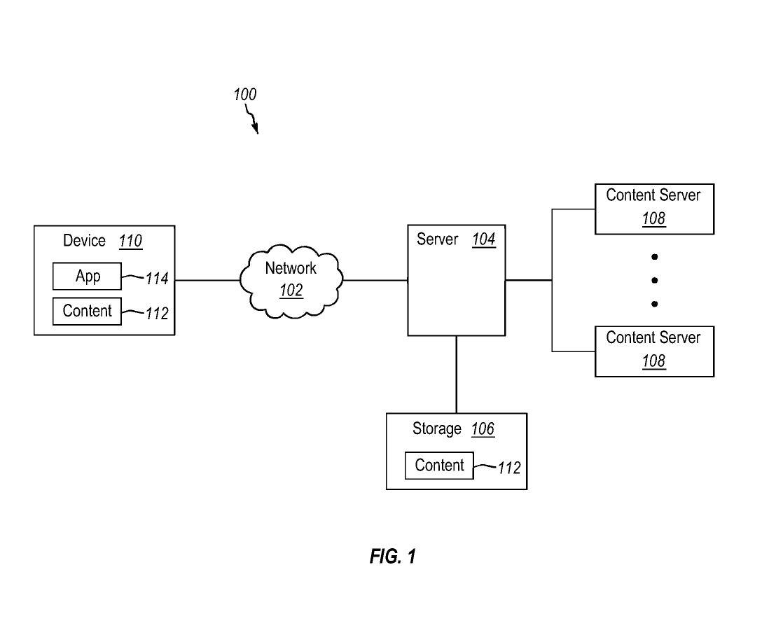

FIG. 1 illustrates an example of a system in which content is delivered and consumed by users. The content is typically consumed when rendered (images, text, video, sound, or the like or combination thereof). A system 100 includes a device 110 that is configured to communicate with a server 104 over a network 102. The device 110 is configured to receive and/or access content 112 from the server 104, which content 112 is consumed by a user as the device 110 renders or presents the content 112 to the user of the device 110.

The content 112 can be presented on the device 110 in multiple forms including, but not limited to, images, text, audio, video, or the like or any combination thereof. For example, the content 112 may be a digital newspaper, magazine, book, video, or the like or any combination thereof. The device 110 may be any device capable of rendering or presenting the content 112. Examples of the device 110 include, but are not limited to, tablet devices, smart phones, laptop computers, portable devices, other computers or the like or any combination thereof.

The device 110 can access the content 112 using a conventional Internet connection (which may be secure) to the server 110 and a browser. Alternatively, the device 110 may access the content 112 in the context of an app that has been installed on the device 110.

The content 112 is typically provided by content providers or is received from content servers 108. The content servers 108 may be owned or managed by content publishers. The content servers 108 may deliver the content 112 to the server 104, which may store the content 104 in storage 106.

The content stored by the server 104 and provided by the content servers 108 can be updated regularly. For example, when the content 112 is a digital magazine, new issues of the digital magazine are provided to the server 104. Each content server may have a separate relationship with the server 104. For example, the server 104 may store multiple issues of a digital magazine for one content server while only storing the most recent issue for another content server 104. The ability to access past issues may also depend on a type of subscription associated with the device 110 or with a particular user. Thus, the subscription can be tied to a device and/or a user.

The ability of the device 110 to access the content 112 stored by the server 104 may also depend on an agreement between the device 110 (or a user using the device 110) and the server 104 (or the owner/operator of the server 104). The server 104, which may operate as a content aggregator for the content servers 108, may provide different plans or subscriptions for accessing the content. Some plans may allow access to the content 112 only while the device 110 in online or has an active Internet connection. Other plans may allow content to be downloaded to the device 110 for offline access. One of skill in the art can appreciate other plans or subscriptions for allowing access to the content 112. The plans can be subscription based plans. In some instances, the content (e.g., a specific article or digital magazine or title) may be purchased by the user of the device 110. Purchased content can typically be accessed at any time regardless of whether the device is actively online and regardless of the subscription.

The content 112 can include, by way of example, many different digital magazines from different publishers or content servers. Each digital magazine or newspaper or other publication may be referred to as a title and a given content provider or publisher may be associated with one or more titles.

In this example, an app 114 is installed on the device 110. The app 114 enables the device 110 (or more specifically the user of the device 110) to browse or otherwise consume the content 112. The content 112 is consumed, by way of example only, when a user accesses a particular title.

The process of selecting a title to access is typically not part of the consumption process and may not be included in the time spent consuming content. However, the ability to browse content or titles in order to select a title to access or consume may be part of the app 114.

For example, images of digital magazine covers (or other content) may be presented in a user interface generated by the app 144. The app 114 may also enable the content to be browsed and/or searched in multiple manners. The content 112 can be organized, displayed, and/or searched by genre, publisher, date, size, popularity, title, alphabetically, by contributors or authors, or the like or any combination thereof. The organization of the content 112 can also be presented according to a consumption history of the device 110 or the like or based on a user profile. A user can use the app 114 to browse the content before selecting specific content or a specific title to consume.

In one example, the server 104 also manages how revenue from the user of the device 110 (as well as other users on other devices) are distributed to the publishers of the content 112. The app 114 may also include software of modules necessary to track or measure which content or which titles are consumed on the device 110. In one example, data that represents which content the user of the device 110 has consumed, can be collected on the device 110 itself by the app 114 and/or by the server 104. This data can include time spent viewing, consuming, or interacting with specific content (e.g., a digital magazine), time spent browsing content, identification of content that is browsed but not necessarily consumed, a user ID, and/or other information. This data or some of this data can be used to determine how any revenue collected from the user of the device 110 is distributed to the publishers of the content 112 consumed on the device 110. This data can remain on the device 110 or be transmitted to the server 104.

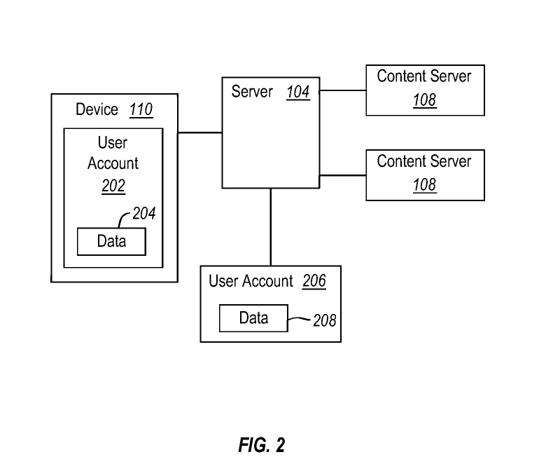

FIG. 2 illustrates another example of the server that distributes content and that performs financial reporting for the content consumed by users. FIG. 2 illustrates the server 104, which communicates with the content servers 108 and which receives content from the content servers 108.

The server 104 also maintains user accounts 202 and 206, which are representative of user accounts generally. Each user account is associated with data as previously described. The data 204 is associated with the user account 202 and the data 208 is associated with the user account 206.

In this example, the user account 202 is associated with the device 110 and a user of the device 110. The data 204 representing the user's interaction or consumption of the content 112 can be collected by the device 110. Typically, the data 204 is uploaded to the server 104 and stored in the storage 106 for processing. The data 204 (and the data 208 and the data for other users) is collected, for example, when the corresponding device accesses or consumes content or on another basis, such as monthly.

The app 114 may include various timers of ways of timing how long the user consumes a particular title. In one example, each title may be associated with its own identifier. The app 114 may maintain data that associates each title with how long the title has been consumed. This data may be reset each month or on another basis. A lifetime measurement may also be retained for each title. In addition, a total consumption time for all content may also be retained on a periodic basis and/or a lifetime basis.

By tracking these time periods (often in terms of minutes or more granularly), the app 114 can determine how long each title is accessed during a given period compared to a total consumption time for the same period. This enables the app 114 or the server 104 to assign a percentage of the total consumption to each title.

There may be instances where a title is being accessed but no content is being consumed. For example, a user may access a particular title and then set the device down with the content still open. In this context, the app 114 may be configured to stop timing when a threshold of inactivity is determined. This can be determined, for example, if no device movement is detected or if no user input is detected (e.g., swiping to change pages, clicks to access links or start video, etc.). This prevents the total time allocated to a particular title from reflecting an inaccurate tally.

More generally, the percentage of time a user spends consuming a particular title determines how much revenue is earned for the publisher of that particular title.

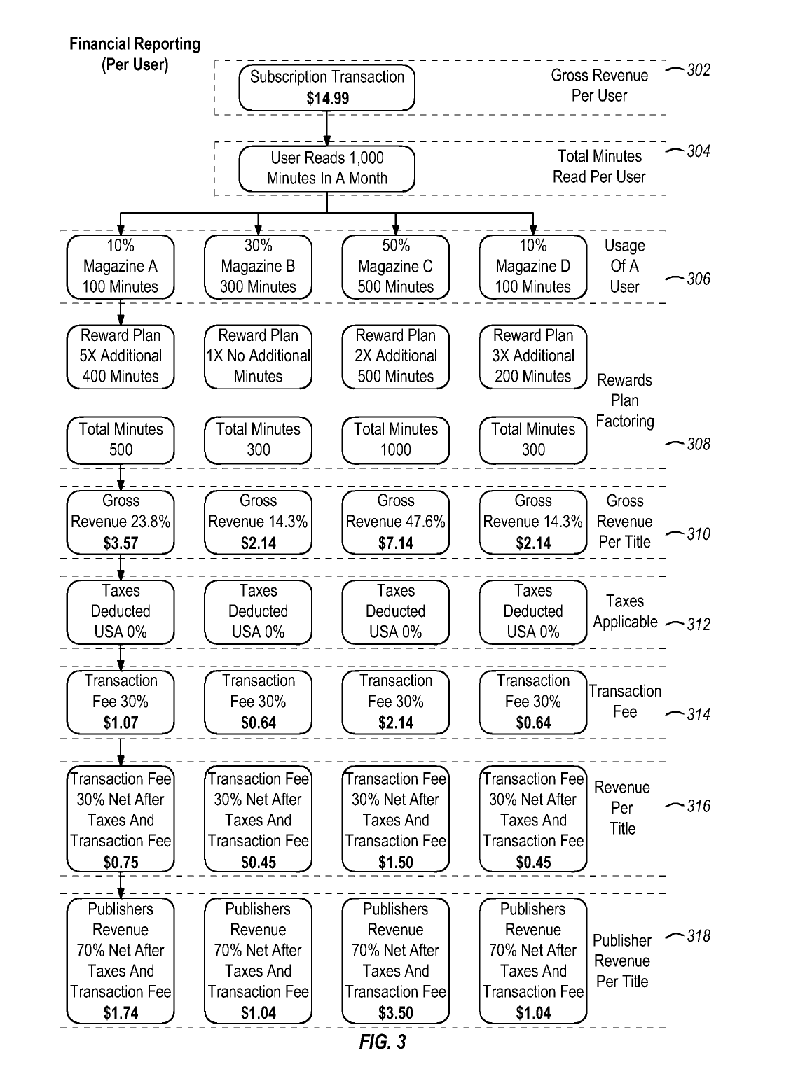

FIG. 3 illustrates a method for distributing revenue. FIG. 3 illustrates that the revenue distributed to a particular publisher depends on the percentage of time spent by the user consuming that publishers title or content. As described in more detail below, embodiments of the invention also contemplate a reward program for publishers that enable the publishers to increase their share of the revenue being distributed. This program incentivizes publishers to make their content more accessible to the users.

The method 300 illustrated in FIG. 3 uses the data collected from the devices of the users to distribute revenue. The data collected by the devices may be augmented by data generated by the server 104 (e.g., reward minutes awarded to publishers). As previously stated, this data includes measurements of the time spent by the user consuming content associated with one or more publishers.

In box 302, the gross revenue from a given user is determined. This is often determined automatically from the plan to which the user subscribed. This can be determined from the server 104.

In box 304, the data collected from the device is used to determine the total number of minutes (or other time unit) during which content was consumed (e.g., read). This data may be automatically transmitted by the device 110 (e.g., by the app 114) without user interaction. This enables the distribution of revenue to be transparent from the user's perspective. The user has access to multiple titles for a subscription fee and does not need to interact with each of the publishers independently. Once transmitted to the server, the data generated at the device can be reset in preparation for the next subscription period.

In box 306, the number of minutes consumed for each specific content (e.g., title) is determined. The data transmitted to the server 104 includes, in one embodiment, total time spent consuming content, titles consumed during the subscription period, and the amount of time spent consuming each individual title.

In box 306 of FIG. 3, the data indicates that the user spent 1000 minutes consuming content. This time is divided between four titles in this example: 100 minutes consuming magazine A, 300 minutes consuming magazine B, 500 minutes consuming Magazine C, and 100 minutes consuming Magazine D.

In box 308 (which is optional in one example) a rewards plan may be implemented to augment the data received from the device for the user. The rewards plan includes, in one example, a way to incentive publishers to improve their digital content. At the beginning of a subscription period, each publisher may begin at the same level. Over the course of the subscription period, points may be awarded to the various publishers. The points can thus be reset for each subscription period (e.g., month).

Making the content more interactive, for example, can result in points being awarded. The content can be made more interactive, for example, by combining different types of content (e.g., text with images, videos, links, or the like). The content can also be made more interactive, and eligible for rewards, by formatting the content for the specific device being used by the user. Content for a tablet device may differ from content for a phone due to the difference in screen real estate. In this manner, any given publisher can increase their share of the revenue by taking advantage of the rewards program.

In this example, Magazine A is rewarded 400 minutes, Magazine B is rewarded no minutes, Magazine C is rewarded 500 minutes, and Magazine D is rewarded 200 minutes.

Without the rewards, Magazine A has 10% of the user's minutes, Magazine B has 30% of the user's minutes, Magazine C has 50% of the user's minutes, and Magazine D has 10% of the user's minutes. These percentages correspond to the share of revenue each publisher receives. When taking the minutes awarded to the publishers into account, the revenue shares change. In one example, the total minutes now includes the user minutes and the reward minutes, which brings the total minutes to 2100 minutes. This accounting of reward minutes is typically performed by the server 104 after the data from the devices has been received and processed.

After taking the reward minutes into account, Magazine A now has a 23.8% share instead of a 10% share, Magazine B has a 14.3% share instead of a 30% share (Magazine B earned no rewards points), Magazine C has a 47.6% share instead of a 50% share), and Magazine D has a 14.3% share instead of a 10% share. This illustrates that the publishers are incentivized to improve their content to receive more rewards since they can effectively increase their share of the revenue. In one example, failing to achieve reward minutes can impact the revenue share. The impact on Magazine B was more severe than on Magazine C because Magazine C earned enough reward minutes to substantially maintain their revenue share.

In box 310, the total gross revenue per title or per publisher is determined. When a publisher has more than one title, the allocation of revenue can be allocated on a per title basis or a per publisher basis. The gross revenue is determined by applying the percentage of each title to the gross revenue. Thus, Magazine A is associated with 23.8% of the gross revenue or $3.57. Similarly, Magazines B, C, and D are associated with, respectively, $2.14, $7.14, and $2.14 of the gross revenue.

In box 312, taxes are deducted from the gross revenue. This may depend on local laws and is implemented accordingly.

In box 314, a transaction fee is deducted from the gross revenue. In this example, the transaction fee is a percentage of the gross revenue. The transaction fee in box 314 may go to a partner that provides an ecosystem for the software or the app. In one example, the systems and/methods disclosed herein are at least partially embodied in an application that is distributed to devices (etc., an iOS app or an android app) as previously described and a fee is paid to the provider of the ecosystem in which the app operates.

In boxes 316 and 318, the remaining amount is divided between the publishers of the content and the content aggregator (e.g., the owner or operator of the server 104). In box 316, another fee is deducted from the remaining net revenue (after taxes and partner transaction fee) and distributed to the server 104 (or owners thereof), which manages the content (enables the distribution of the content, tracks usage or consumption of the content, etc.) and which publishes the app or other software.

In box 318, the remaining revenue is distributed to the various publishers on a per title basis according to the percentages described in box 310 (or in box 306). The content aggregator receives, in one example, 30% of the net amount remaining after taxes and transaction fee and the publisher receives 70% of the net amount remaining for the associated title. Generally, 30% of the total net remaining amount is provided to the content aggregator and 70% is distributed to the publishers based on the data received from the devices and/or the reward minutes.

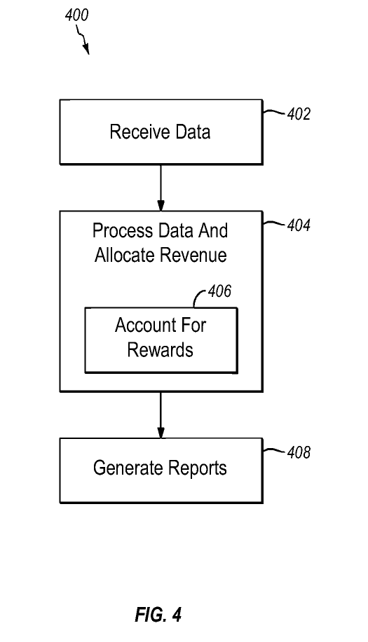

The method of FIG. 3 is typically performed on a periodic basis (e.g., monthly). FIG. 4 illustrates a method for distributing revenue from the perspective of the server 104. In the method 400, data is received from devices in box 402. The data can be received for every user that has a subscription. The data can be received or collected in various manners. The data can be collected daily, monthly, or the like. The apps of the devices being used to consume the content may push the data on a periodic basis. The collection of data may be staggered such that not all devices report at the same time. In addition, the subscription periods may also be staggered to reduce the load on the server 104 (which may be a server farm or a plurality of servers).

In box 404, the data collected (e.g. pulled from the devices) or received (e.g., pushed by the devices) is processes. Processing the data can include determining a revenue share for each title for each user as described herein. Then, processing data can further include combining the data for each of the users. This can facilitate the distribution of the revenue to the actual publisher on a per title basis and not just on a per user basis. In other words, the publisher can be compensated for their content for multiple users at the same time rather than for each user individually. The server 104, however, retains the ability to report on a per user basis if necessary.

When processing the data in box 404, the server 104 may also account for rewards in box 406, which is performed as previously discussed. In one example, the reward minutes are applied to each user. When two users consume the same title, the reward minutes are applied to the minutes of each user since the revenue share is initially processed by the server on a per user basis before being combined.

In box 408, financial reports are generated and distributed to the publishers. Payment can then be distributed. In addition to providing financial report that describes the publishers revenue share, the report may also include information describing the specific articles consumed within each title. In this manner, this aids the publisher by providing feedback relative to their content. In addition, it enables the ability to distribute revenue on a per article basis rather than on a per title basis.

Embodiments of the invention may enable a publisher to receive more revenue that from the sale of a single issue. For example, if a user spends a certain percentage of time consuming a particular title, then the revenue share may be greater than the price of a single issue. If an issue costs $2.99, then the publishers share of a purchased issue if $1.46. In this example, any consumption more that 19.27% of the user's time generates more revenue that the sale of a single copy. This also provides incentive to improve the content.

One of skill in the art can appreciate, with the benefit of the present disclosure, that the percentages used to share revenue can vary. In addition, the percentages can be applied to gross amounts, net amounts, or the like or in other manners.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms. Examples include, but are not limited to, the following: a recordable type medium such as a floppy disk, a hard disk drive, a CD, a DVD, a digital tape, a computer memory (local or remote), or the like.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method for distributing revenue generated from consumption of content, the method comprising:
receiving data from a device operating in a network at a server, wherein the data is associated with a revenue amount and with titles consumed by a user of the device;
processing the data to allocate a portion of the revenue amount to each title consumed by the user of the device; and
reporting on the allocation of the revenue amount to publishers of the titles consumed by the user.

2. The method of claim 1, wherein the data is collected by an app operating on at least some of the devices.

3. The method of claim 1, wherein the data includes total minutes consuming the content and minutes consuming each title consumed by the user.

4. The method of claim 3, wherein processing the data includes allocating a percentage of the revenue amount to a particular publisher that correspond to a percentage of minutes spent consuming the title of the particular publisher.

5. The method of claim 3, wherein processing the data further comprises resetting the data for a next subscription period.

6. The method of claim 1, further comprising combining the allocation of revenue shares for all devices for each publisher.

7. The method of claim 1, further comprising augmenting the data with reward data associated with the publishers for each user's data before processing the data to allocate a portion of the revenue amount to each title.

8. A method for generating revenue for content consumption, the method comprising:
receiving input from a user selecting content to consume;
determining that the user consumes the content;
for each individual title included in the consumed content, tracking an amount of time during which each individual title was consumed;
tracking a total amount of time during which all the content was consumed, wherein the amount of time of each individual title, each individual title consumed, and the total amount of time are stored in data; and
transmitting the data to a server, wherein the data is used to allocate revenue from the user to publishers of each individual content consumed by the user.

9. The method of claim 8, further comprising resetting the data for each subscription period.

10. The method of claim 8, further comprising presenting a user interface that permits the content to be browsed, wherein time spent browsing is not included in the amount of time or the total amount of time used to allocate the revenue.
